(19) United States
(12) Patent Application Publication
(10) Pub. No.: US 2008/0133592 A1
(43) Pub. Date: Jun. 5, 2008

(54) BIRD IDENTIFICATION SYSTEM

(76) Inventor: James Peters, Edmonton (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/565,329

(22) Filed: Nov. 30, 2006

(51) Int. Cl. G06F 17/30

(52) U.S. Cl. 707/104.1; 707/E17.009

(57) ABSTRACT

A flora and fauna identification apparatus includes a flora and fauna database that has a plurality of records. Each record has a color representation of a particular flora or fauna, along with a plurality of fields of identification criterion including physical topography and coloration of selected regions of the physical topography. A processor that selects records that are possible matches from the database based upon input of identification criterion by a user through a user interface. The user interface has a physical topography selector from which the user selects, a selected physical topography most closely resembling a flora or fauna to be identified. There is also provided a pallet of colors, from which the user sequentially selects colors and places the colors on selected regions of the selected physical topography. The processor determines at each step the records in the database that are possible flora or fauna matches.

### FIELD

The present invention relates to a user interface that is used with software to assist bird watchers in identifying birds that have been sighted.

### BACKGROUND

U.S. Pat. Nos. 6,546,368 and 6,772,142 are examples of existing approaches to bird identification with the assistance of software.

### SUMMARY

According to the present invention there is provided a flora and fauna identification apparatus. There is a flora and fauna database that has a plurality of records. Each record has a color representation of a particular flora or fauna, along with a plurality of fields of identification criterion including physical topography and coloration of selected regions of the physical topography. There is provided a user interface, and a processor that selects records that are possible matches from the database based upon input of identification criterion by a user through the user interface. The user interface has a physical topography selector from which the user selects, from a plurality of possible physical topographies, a selected physical topography most closely resembling a flora or fauna to be identified. The processor determines the records in the database that are possible matches based upon the selected physical topography. There is also provided a pallet of colors, from which the user sequentially selects colors and places the colors on selected regions of the selected physical topography. The processor determines the records in the database that are possible flora or fauna matches as each color is added and placed on the selected region of the physical topography template.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a schematic view of a flora and fauna identification system.

FIG. 2 is a flowchart of a method for identifying flora and fauna.

FIGS. 3 through 8 are screenshots of a program used to identify flora and fauna.

FIG. 9 is a schematic view of a topography template with physical features being added.

### DETAILED DESCRIPTION

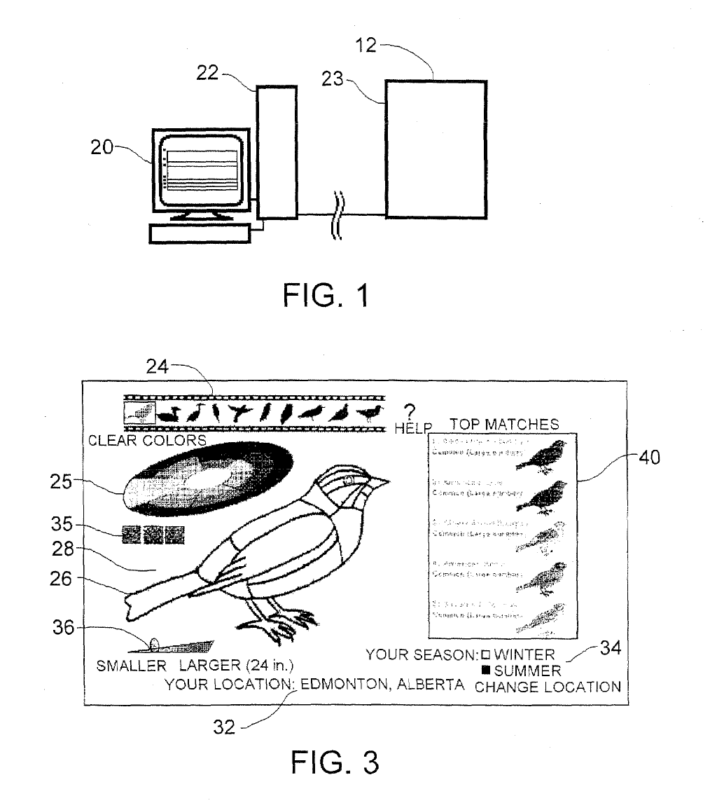

The preferred embodiment, a flora and fauna identification apparatus will now be described with reference to FIGS. 1 through 9. While the description below is given in relation to bird identification, it will be understood that the same principles may be applied to identify other types of flora and fauna, such as flowers, butterflies, frogs or snakes.

Referring to FIG. 1, the bird identification apparatus includes a bird database 12 that has a plurality of records. Each record in database 12 has a color representation of a particular bird, along with a plurality of fields of identification criterion such as physical topography and coloration of selected regions of the physical topography. Other criteria may include geographical location based upon migratory patterns, distinctive physical features, texture, observed natural habitat, or relative size ranking. A user interface 20 allows a user to access database 12, and a processor 22 selects records that are possible matches from database 12 based upon input of identification criterion by a user through user interface 20. While one particular arrangement has been shown, there are a variety of ways providing database 12, user interface 20, and processor 22. For example, user interface 20 may be a computer as depicted. The user interface may also be a portable computer, such as a laptop, PDA, cell phone, etc. Database 12 may be an online database that the user interface 20 connects to, such as a web page, or it may be loaded directly onto the user interface, which may be preferable if a portable computer is used, which will not have an internet connection in the field. If database 12 is an online database, the processor 22 in the remote server 23 may be used. Alternatively, if software is loaded onto the user interface 20, the processor 22 of user interface 20 may be used. Alternatively, certain functions may be divided between user interface 20 and database 12 to improve performance, or a combination of the two, as will be known to those in the art.

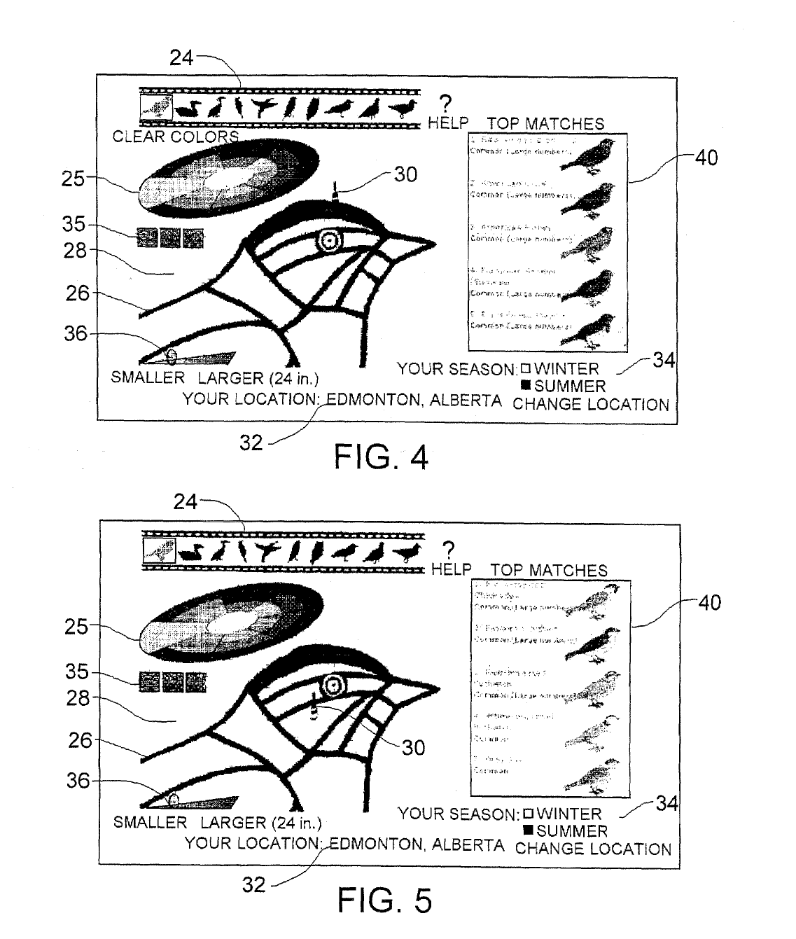

Referring to FIG. 3, user interface 20 has various selectors which allow the user to narrow the possible type of bird that was observed. For example, a physical topography selector 24 may be provided, from which the user selects a physical topography 26 most closely resembling the bird to be identified from a plurality of possible physical topographies displayed in selector 24. Once selected, physical topography 26 then appears on a working area 28. From this selection, processor 22 determines the records in database 12 that are possible matches. The user then sequentially selects colors from a pallet 25 of colors and places the colors on selected regions of physical topography 26. Referring to FIG. 4, a paintbrush 30 is used to represent a color selection tool. Processor 22 provides the color representations taken from records in database 12 of the possible matches as each color is added and placed on the selected region of the physical topography template 26. Placing paintbrush 30 over an area of topography template 26 that is more detailed may cause that area to be magnified on working area 28. Other identification criteria that may be specified include:
Geographical location based upon migratory patterns. The user interface 20 allows the user to input the geographical location and time of year of the sighting. The selected location is indicated in the location field 32, and the selected season is represented by the season field 34.
Distinctive physical features. The user interface 20 enables the boundaries of the selected physical topography 26 of the bird to be modified by the user to denote distinctive physical features. An example of this is shown in FIG. 9, where a plume 42 and a rear peak 44 are added to physical topography 26 in order to distinguish the type of bird to be identified. While FIG. 9 shows optional features that may be included specific to the physical topography 26, it may also be done by allowing the lines on topography 26 to be manipulated, or by allowing topography 26 to be stretched or shrunk in a certain direction to a more likely shape. Other options to specify the particular morphology include menus to specify characteristics such as bill shape (including thick, thin, short, long, hooked, etc.), tail shape (notched, forked, rounded, pointed, upright, square, fan, etc.), tail/neck/leg length, including actual or relative sizes (very short, short, average, long, very long), head crest, outer tail feather (corner, side, tip, banding, etc.), inner tail feather (corner, side, edge), or wing tip colour. If desired, some menus or options may be available for certain topographies and not others. Furthermore, selecting certain features may adjust topography 26 on display area 28.
Texture. Referring to FIG. 3, the user interface 20 allows the user to select a selected texture from a plurality of possible textures shown in a texture toolbar 35.
Relative size ranking. Referring to FIG. 3, the user interface 20 allows the user to select a size by either providing a measurement scale 36 that the user may use to indicate the approximate size of the bird to be identified, or by providing relative size rankings from which a selected relative size ranking may be selected.
Observed natural habitat. The user interface 20 may also allow the user to select a selected habitat from a plurality of possible natural habitats (not shown). One option is to displaying picture showing various habitats, or a menu may also be provided, with a list including habitats such as: field, forest, lake, marsh, alpine, desert, ocean, shore, etc. Another option would be to provide a toolkit of natural object to drag onto the display area 28.
Behaviour. Another menu (not shown) may specify the particular behaviour of the bird, such as swimming, dabbling, diving, plucks, wades, forages, walks, perches, tree cling, bobbing tail, flitting, etc.
Movement patterns. The user may also be able to specify a bird's flight pattern, again by using a menu including options such as soaring, flocking, tight formation, loose formation, “V” formation, steady, bobbing, fly catching, level, etc. The user may also specify movement on land: hopping, walking, etc. The user may also specify movement in relation to water: swimming, dabbling, diving, etc.

As more information is entered, records that are possible matches are ranked, and a list 40 of possible matches is displayed on the user interface. A score may be assigned based on how closely each match corresponds to the criteria the user has entered. In this way, the user may be able to identify the matching bird without having to specify all the possible criteria. In addition, the order in which the identification criteria are specified may proceed in any practical order, such that the observed natural habitat, geographic location and time of year may be specified to narrow the list of possible records before proceeding to specify the physical characteristics of the bird itself. It is important to note that the user is not limited to a single selection in each category. There may be situations in which more than one selection may be made in each category. For example, some birds like to be on the edge of field and forest and will be observed in each. For example, some water fowl will both swim and dabble, but will not dive; other water fowl will swim and dive, but will not dabble.

The ranking may be done in different ways. For example, an algorithm may generate a matching score for each record by comparing each criteria entered by the user with the criteria stored in the database. Each record is given a score based on whether the criteria is a perfect match, a near perfect match, does not match, or unspecified. For example, if black was entered, this may be scored as near perfect for a record that is dark brown, and wrong for a record that is light green. As another example, a color specified for the throat will also be compared to the color of the neck in the records, but not the tail. Thus, the algorithm takes into account that the user may be mistaken on some details. As a result, an error in user input when making selection from the various identification criterion will affect the ranking of a particular record, but does not eliminate the record as a possible match. For example, an error in the selected region in which a color is placed will affect the ranking of a record, but it will not be eliminated as a possible match. As more information is entered, processor 22 updates the rankings and generates a new list of possible matches. The algorithm may also incorporate a machine learning algorithm, where previous successful matches made by users are used as a training set. This may be useful when dealing with colors, since, depending on the pallet of colors used, the number of shades available may be limited, and some users may choose a different shade that does not correspond with the database record.

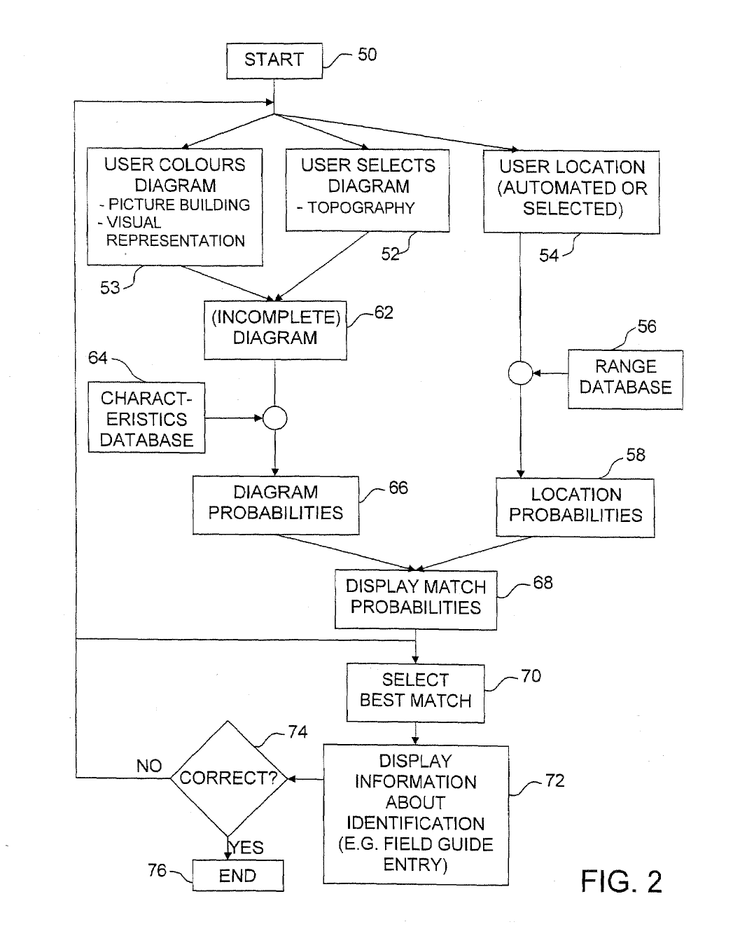

Referring to FIG. 2, an example of a flowchart to implement software with three selection criteria is shown. The process begins at step 50. From this step, the user will either select a topography in step 52, select a color for the topography in step 53, or select a location in step 54. If a location is selected, the location is compared against the range database in step 56, possible matches and their probabilities are determined based on location in step 58, and displayed in step 60. Note that the location may be automatically entered based on the user's preferences or location, in which case the process would proceed automatically from start at step 50 to displaying possible matches and their probabilities in step 60. If a color or topography is selected in steps 53 or 52, respectively, the process proceeds to compare the entered information even when incomplete in step 62 to the characteristics diagram in step 64. Probable matches are then determined in step 66 based on the diagram, and the possible matches and their probabilities are displayed in step 60. The user then either proceeds to step 68 and selects the best match, or returns to the top to change or add more detail in steps 52, 53 or 54. Once the best match has been selected in step 68, information is then displayed about the match. If not successful, the user may again return to the top to correct or add more information.

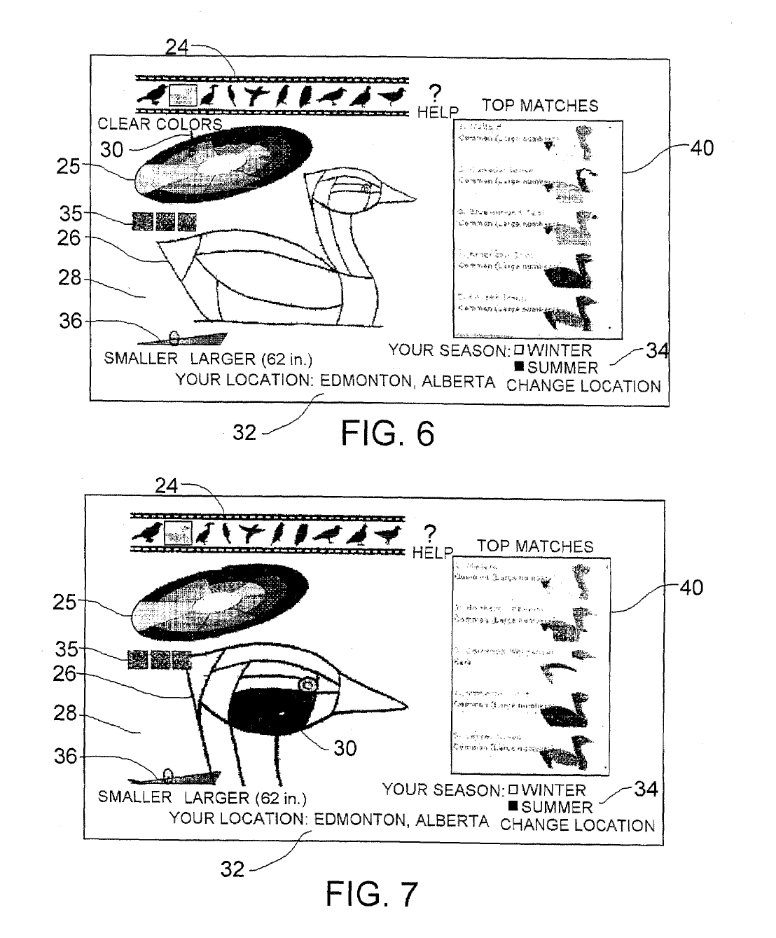

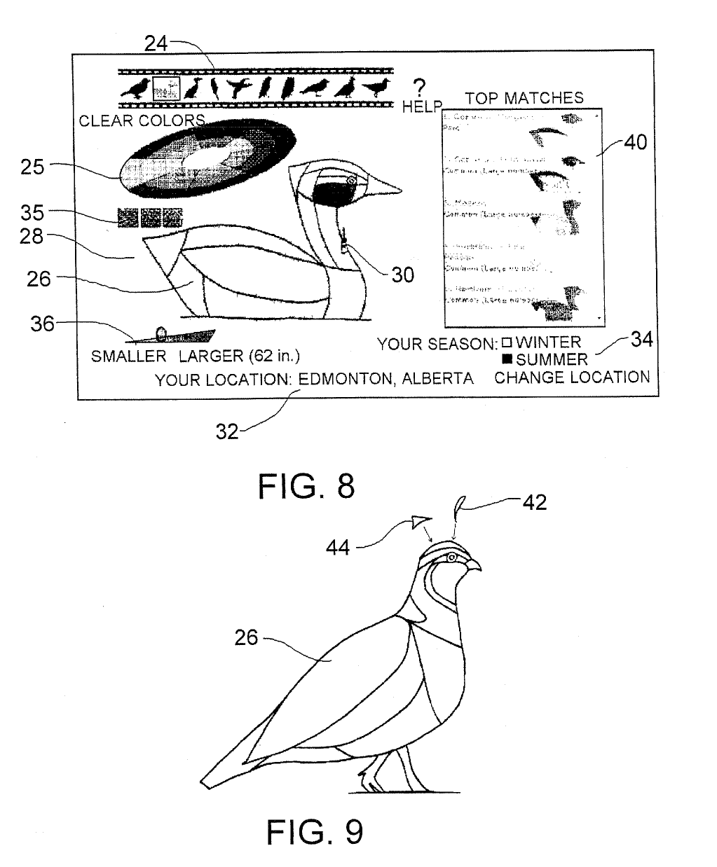

Referring to FIGS. 3 through 5, an example of a program implementing the procedure described above is shown. Referring to FIG. 3, physical topography 26 is selected from a set of topographies displayed in topography selector 24, which then appears in working area 28. At the same time, a set of best matches appears in list 40. Paintbrush tool 30 is used to select a color from pallet 25. Referring to FIG. 4, as paintbrush tool 30 moves toward the head, the head is magnified such that the user is able to color the desired area more easily. List 40 is updated to account for the color that has been specified. Referring to FIG. 5, list 40 is updated again as the user indicates another color on topography template 26. Referring to FIG. 6, the user has reset the application, and has selected a different topography template 26. Steps similar to those described above are taken through FIGS. 7 and 8, with list 40 being updated after each step is taken.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiments without departing from scope of the claims.

What is claimed is:

1. A flora and fauna identification apparatus, comprising:
a flora and fauna database having a plurality of records, each record having a color representation of a particular flora or fauna, along with a plurality of fields of identification criterion including physical topography and coloration of selected regions of the physical topography;
a user interface;
a processor that selects records that are possible matches from the database based upon input of identification criterion by a user through the user interface;
the user interface having:
a physical topography selector from which the user selects, from a plurality of possible physical topographies, a selected physical topography most closely resembling a flora or fauna to be identified, the processor determining the records in the database that are possible matches based upon the selected physical topography; and
a pallet of colors, from which the user sequentially selects colors and places the colors on selected regions of the selected physical topography, the processor determining the records in the database that are possible flora or fauna matches as each color is added and placed on the selected region of the physical topography template.

2. The flora and fauna identification apparatus of claim 1, wherein the flora and fauna, is selected from one of birds, flowers, butterflies, frogs, snakes, spiders, fish, trees, or rocks.

3. The flora and fauna identification apparatus of claim 1, wherein the identification criterion includes geographical location based upon migratory patterns and the user interface allows the user to input the geographical location and time of year of the sighting.

4. The flora and fauna identification apparatus of claim 1, wherein records that are possible matches are ranked and an error in the selected region in which a color is placed affects a ranking of a record but does not eliminate the record as a possible match.

5. The flora and fauna identification apparatus of claim 1, wherein the identification criterion includes distinctive physical features and the user interface enables the user to allows the user to select, from several physical features, a selected physical feature.

6. The flora and fauna identification apparatus of claim 1, wherein the identification criterion includes texture and the user interface allows the user to select, from a plurality of possible textures, a selected texture.

7. The flora and fauna identification apparatus of claim 1, wherein the identification criterion includes observed natural habitat and the user interface allows the user to select, from a plurality of possible natural habitat, a selected habitat.

8. The flora and fauna identification apparatus of claim 1, wherein records that are possible matches are ranked and an error in user input when making selection from the identification criterion effects a ranking of a record but does not eliminate the record as a possible match.

9. The flora and fauna identification apparatus of claim 1, wherein the identification criterion includes a relative size ranking, and the user interface allows the user to select, from several relative size rankings, a selected relative size ranking.

10. The flora and fauna identification apparatus of claim 1, wherein the identification criterion includes a behaviour criterion, and the user interface allows the user to select, from several behaviours, a selected behaviour.

11. The flora and fauna identification apparatus of claim 1, wherein the identification criterion includes a movement criterion regarding movement on land, air or water, and the user interface allows the user to select, from several movement criterion, a selected movement criterion.

12. A method of identifying flora and fauna comprising:
providing a flora and fauna database having a plurality of records, each record having a plurality of fields of identification criterion including physical topography and coloration of selected regions of the physical topography;
providing a user interface;
providing a processor that selects records that are possible matches from the database based upon input of identification criterion by a user through the user interface;
using the user interface:
selecting a physical topography from a plurality of possible physical topographies, the selected physical topography most closely resembling a flora or fauna to be identified,
having the processor determine the records in the database that are possible matches based upon the selected physical topography; and
selecting a color from a pallet of colors placing the color on a selected region of the selected physical topography,
having the processor determine the records in the database that are possible flora or fauna matches as each color is added and placed on the selected region of the physical topography template.

13. The method of claim 12, wherein the flora and fauna is one of birds, flowers, butterflies, frogs, snakes, spiders, fish, trees, or rocks.

14. The method of claim 12, wherein the identification criterion includes geographical location based upon migratory patterns and the method further comprises the steps of inputting the geographical location and time of year of the sighting.

15. The method of claim 12, further comprising the step of having the processor rank records that are possible matches are ranked, wherein an error in the selected region in which a color is placed affects a ranking of a record but does not eliminate the record as a possible match.

16. The method of claim 12, wherein the identification criterion includes distinctive physical features and the user interface enables the user to allows the user to select, from several physical features, a selected physical feature.

17. The method of claim 12, wherein the identification criterion includes texture and the method further comprises the step of selecting, from a plurality of possible textures, a selected texture.

18. The method of claim 12, wherein the identification criterion includes observed natural habitat and the method further comprises the step of selecting, from a plurality of possible natural habitat, a selected habitat.

19. The method of claim 12, further comprising the step of having the processor rank records that are possible matches are ranked, wherein an error in user input when making selection from the identification criterion effects a ranking of a record but does not eliminate the record as a possible match.

20. The method of claim 12, wherein the identification criterion includes a relative size ranking, and the method further comprises the step of selecting, from several relative size rankings, a selected relative size ranking.

21. The method of claim 12, wherein the identification criterion includes a behaviour criterion, and the user interface allows the user to select, from several behaviours, a selected behaviour.

22. The method of claim 12, wherein the identification criterion includes a movement pattern criterion regarding movement on land, in the air or on water, and the user interface allows the user to select, from several movement pattern criterion, a selected movement pattern criterion.
